(19) United States
(12) Patent Application Publication
(10) Pub. No.: US 2011/0263182 A1
(43) Pub. Date: Oct. 27, 2011

(54) Beehive enclosure with moisture elimination

(76) Inventors: Dennis Robert Custer, West Granby, CT (US); George Cosma, Windsor, CT (US)

(21) Appl. No.: 12/799,278

(22) Filed: Apr. 22, 2010

(51) Int. Cl. A01K 47/06

(52) U.S. Cl. 449/15

(57) ABSTRACT

An enclosure cover for collecting and disposing of unwanted moisture within honeybee hives during periods of temperature and humidity conditions that promote alternate freezing and thawing. An internal cover surface collects and condenses moisture produced by the bees' metabolism which otherwise may be deposited on the internal surface of the cover as frost and later thaw, causing droplets of cold water to fall on the clustered bees. The enclosure cover is arranged to direct and channel collected water from the condensation surface and discharge the same outside of the hive.

### BACKGROUND OF THE INVENTION

Excessive moisture within a beehive creates an unhealthy environment for bees during colder months. High humidity promotes decay of the wooden structures, mold growth and may contribute to dysentery and other health problems. During cold periods the bees form a cluster within and around the combs of honey, which supply food when foraging is no longer possible. The bees produce heat but the inside space of the hive is essentially at the same temperature as the outside. The outer layers of the cluster are near the cold ambient temperature while the inner core of the cluster can maintain 90+ F degrees. Warm bees from the core feed on stored honey and gradually work to the outer layer of the cluster to change places with cold bees. While the bees can survive dry cold alone, a cold wet bee cannot survive.

A common means of minimizing humidity in the hive involves placing absorbent materials such as crumpled paper, dry leaves or scraps of carpet in an empty box on top of the hive proper. Initially effective, it becomes less so as the material becomes saturated and continues to hold moisture within the hive.

An alternative means of reducing moisture is to provide free ventilation where the airflow carries some of the humidity out of the hive. However, an excessive flow of air in the winter draws excessive heat from the cluster and must be minimized. Also, as a practical matter, airflow is often restricted by snow and ice accumulation or entrance reducers to keep out mice and pests.

A general object of the present invention is to provide an improved method of collecting and discharging excess moisture from a beehive.

Another important object of the present invention is to provide a simple replacement cover that may be added to any existing hive without modification.

### SUMMARY OF THE INVENTION

The principle problem in protecting bees from excess humidity is in preventing condensation derived from moisture drops from accumulating in such a way that they can drop onto semi-dormant bees. When inspecting a hive in winter, it is common to find a layer of frost adhering to the underside of the cover. This moisture is the result of the heat of metabolism of the living cluster as they feed on stored honey. The small amount of heat generated nevertheless causes vapor to rise and condense upon the first cold surface it contacts.

U.S. Pat. No. 2,584,304 attempts to solve the problem of condensation by providing multiple moisture collection channels. However, the condensation is prone to collect on the underside of the channels and this defeats the intent.

U.S. Pat. No. 3,438,070 claims an enclosure to protect the hive. It mentions condensation but does not address the removal of moisture from the hive.

In accordance with the present invention and in fulfillment of the foregoing objects, a beehive enclosure is provided with a bottom wall and a sidewall structure extending substantially vertically upwardly therefrom. A removable cover adapted to rest on the sidewall structure is also provided and has an interior surface which is elevated at a central portion and inclined downwardly therefrom to its perimeter. A moisture collection means at the perimeter extends along and throughout the length of the lower marginal edge of the inclined portion of the surface. The collection means is slightly inclined to conduct collected moisture to at least one predetermined discharge location. At the discharge location a port means serves to discharge the moisture externally of the cover and enclosure.

The interior surface of the cover may take a triangular configuration or may be parti-cylindrical or, various other arcuate or linear configurations may be employed with elevated portions.

The collection means take the form of small elongated channels extending throughout the length of the lower marginal edges of any internal surface selected.

Preferably a spout is provided at the port means to discharge collected moisture in spaced relationship with the cover and enclosure and a porous fabric membrane may be disposed beneath the surface to restrict excessive air flow and prevent bees from reaching the condensing surface.

### DESCRIPTION OF THE DRAWINGS

FIG. 1 of the drawings is a vertical sectional view of a prior art beehive enclosure,

FIG. 2 is a vertical sectional view of a beehive enclosure forming a first embodiment of the present invention,

FIG. 3 is an enlarged sectional view showing the relationship of moisture carrying channels and their discharge spouts,

FIG. 4 is a schematic top view of an enclosure cover showing the location of discharge spouts on the cover,

FIG. 5 is a front schematic of the cover again showing the arrangement of discharge spouts, and

FIG. 6 is a vertical sectional view of a parti-cylindrical beehive forming an alternative embodiment of the invention.

### DESCRIPTION OF PREFFERED EMBODIMENTS

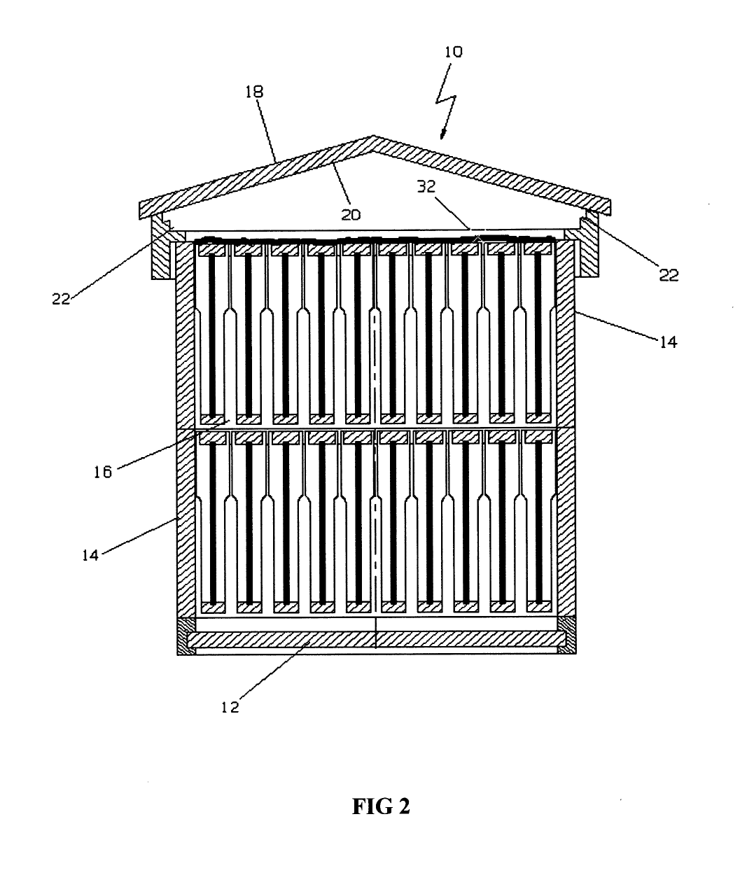

Referring particularly to FIG. 2, a beehive enclosure is indicated generally at 10 and comprises a substantially horizontal bottom wall 12 and a side wall structure 14, 14 connected with the bottom wall and extending substantially vertical upwardly therefrom. In FIG. 2 the beehive enclosure 10 takes a generally rectangular configuration and has a pair of end walls 16, 16 at opposite ends of the sidewalls 14, 14. A removable cover 18 rests on and is supported by the sidewall structure in substantially airtight relationship therewith. Cover 18 has a substantially triangular internal surface 20 which is elevated at a central portion and which is inclined downwardly from the central portion to its perimeter. Internal surface 20 is smooth and nonporous, constructed of aluminum, plastic, etc., for the collection of condensation thereon as a result of moisture rising from a cluster of bees in the beehive enclosure. The inclination of the surface results in droplets of water from melting condensation migrating by gravity toward the lowest point along the lower marginal edges of the internal surface 20. In freezing temperatures, frost forms on the internal surface 20 and thereafter as the temperature rises, the frost melts and the droplets follow the surface to the lowest point, as stated.

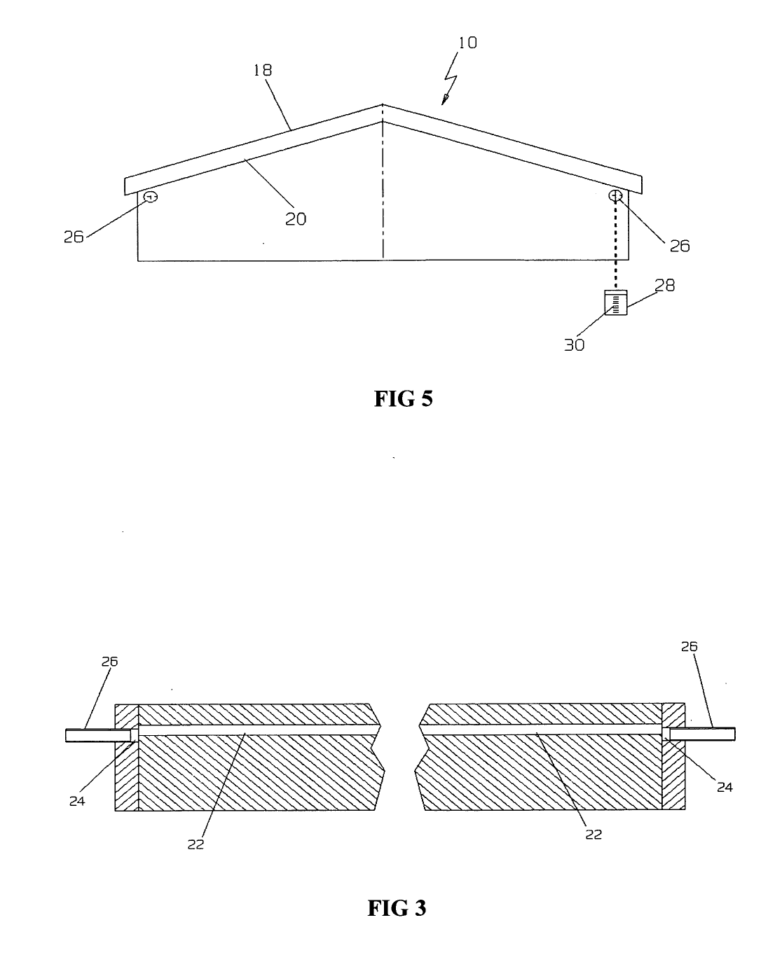

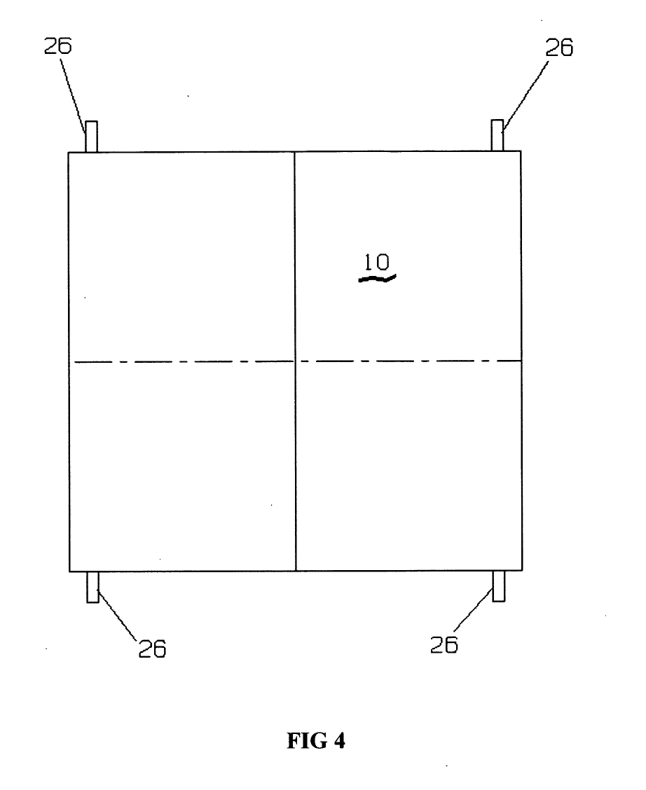

A moisture collection means is disposed at the perimeter or lower marginal edges of the internal surface 20 and may take the form of small elongated channels 22, 22 along the length of the internal surface 20. The channels 22, 22 may be slightly inclined or, even with a level collection means, uneven terrain under the beehive may serve to conduct the collected moisture to at least one predetermined discharge location. As illustrated in FIG. 3, ports 24, 24 at discharge locations conduct the moisture outwardly through the cover for discharge externally of the cover. Preferably, and as also shown in FIG. 3 small spouts 26, 26 are provided at the ports 24, 24 respectively to ensure discharge of the water in spaced relationship with the beehive enclosure 10.

Also shown in FIG. 5, a collection and measuring apparatus 28 may be provided for receiving water discharged from a spout 26. A gauge 30 on the device can be monitored to determine the amount of moisture discharged over a period of time and the health of the bees in the hive can be determined from the amount of discharge.

Reverting to FIG. 2, a porous fabric membrane is shown disposed between the moisture collection surface 20 and the main portion of the beehive enclosure 10. The membrane 28 allows moisture to pass upwardly to the surface 20, but restricts excessive airflow and prevents the bees from fouling the condensing surface 20.

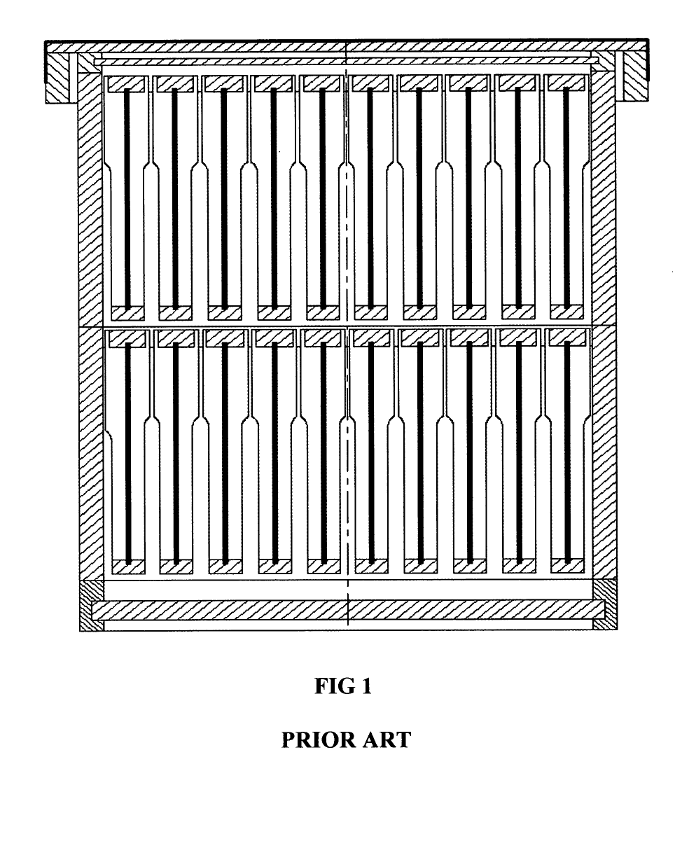

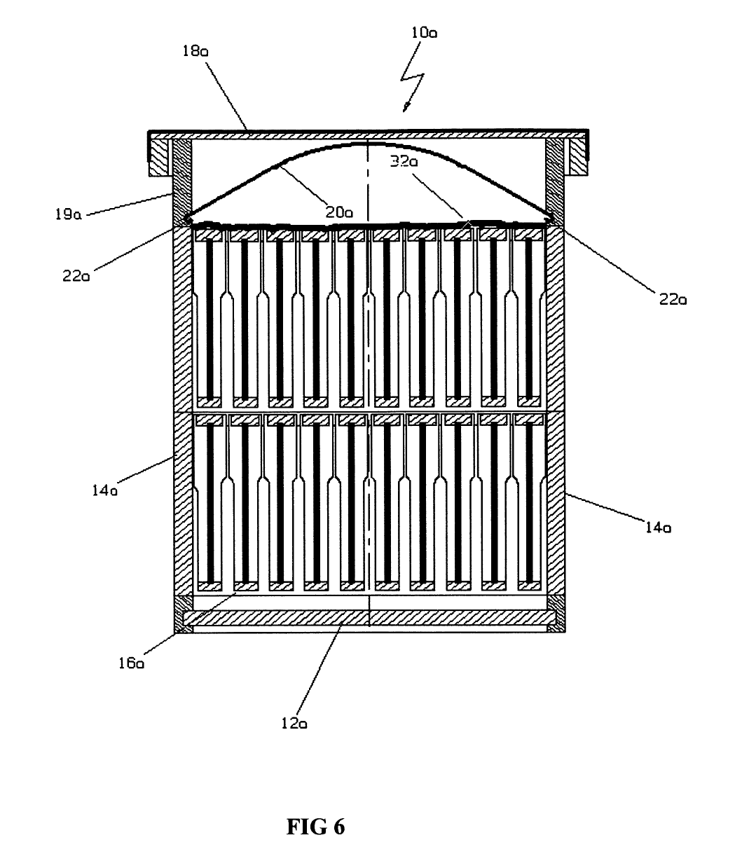

Referring now to FIG. 6, beehive enclosure 10a has a bottom wall 12a sidewalls 14a, 14a and end walls 16a, 16a all of which may be substantially identical with aforementioned walls 12, 14, 16. A standard removable cover 18a has a flat top like the cover of the prior art beehive in FIG. 1, but a small housing 19a is inserted between the beehive proper and the cover 18a. Within the interior of the housing 19a, a condensation surface 20a takes a parti-cylindrical configuration and may have a smooth nonporous surface similar to that of the surface 20. At lower end marginal portions of the cover 20a small elongated slightly inclined channels 22a, 22a collect and discharge the moisture from melting condensation as in the embodiment of FIG. 2. The use of a flat cover and auxiliary housing as in FIG. 6 or a single peaked or triangular cover as in FIG. 2 is of course a matter of preference for the beekeeper.

From the foregoing it will be apparent that a simple and yet effective means has been provided for ensuring that water droplets do not fall on a bee cluster in cold weather and are instead conducted outwardly of the beehive enclosure for harmless disposal. Significant improvement in the health of bees within a beehive enclosure is thus achieved.

1. A beehive enclosure comprising a substantially horizontal bottom wall, a side wall structure connected with the bottom wall and extending substantially vertically upwardly therefrom, a removable cover adapted to rest on and be supported by the side wall structure in substantially air tight relationship therewith, said cover having an internal downwardly exposed condensation collecting surface which is elevated at least at one portion and which is inclined downwardly from the elevated portion to its perimeter, a moisture collection means disposed at the perimeter and extending along and throughout the length of the lower marginal edge of the inclined portions of the internal surface, said collection means serving to conduct collected moisture to at least one predetermined discharge location, and port means at said discharge location to conduct the collected moisture outwardly through the cover for discharge externally of the enclosure.

2. A beehive enclosure as set forth in claim 1 wherein the internal surface of the cover comprises a pair of similar downwardly exposed planar side surfaces in a substantially triangular configuration with each end of the cover enclosed.

3. A beehive enclosure as set forth in claim 2 wherein the moisture collection means comprises a pair of small-elongated channels respectively extending along the base of a side surface of the triangle.

4. A beehive enclosure as set forth in claim 1 wherein the internal surface of the cover takes a parti-cylindrical configuration.

5. A beehive enclosure as set forth in claim 4 wherein the moisture collection means comprises a small channel, which extends along and throughout the length of the lower marginal edge of the parti-cylindrical surface.

6. A beehive enclosure as set forth in claim 1 wherein the port means includes a spout to discharge collected moisture in spaced relationship with the cover and enclosure.

7. A beehive enclosure as set forth in claim 1 wherein the internal surface of the cover is of a smooth and non-porous material so as to be conducive to the disposition of condensation thereon.

8. A beehive enclosure as set forth in claim 1 wherein a porous fabric membrane is disposed over the top opening of the side wall structure between the internal; surface of the cover and the interior of the enclosure.

9. A beehive enclosure as set forth in claim 1 wherein a collection and measurement means is provided to receive water discharged from the enclosure whereby to provide a means for monitoring the health of the bees in the hive.
